(19) United States
(12) Patent Application Publication
(10) Pub. No.: US 2019/0346744 A1
(43) Pub. Date: Nov. 14, 2019

(54) DETACHABLE VIDEO RECORDING SENSING LAMP

(71) Applicant: CHIN-MU HSIEH, TAINAN CITY (TW)

(72) Inventor: CHIN-MU HSIEH, TAINAN CITY (TW)

(21) Appl. No.: 15/975,987

(22) Filed: May 10, 2018

(51) Int. Cl. G03B 15/05; F21V 23/06; F21V 23/04

(52) U.S. Cl. CPC G03B 15/05; F21V 23/06; F21W 2131/10; G03B 2215/056; F21V 23/0464

(57) ABSTRACT

A detachable video recording sensing lamp includes a light source body and at least one functional unit. The at least one functional unit is detachably electrically connected to the light source body. The user or the consumer can perform assembly according to the desired function. When one of the functional units is damaged, only the damaged functional unit is replaced without the need to replace the whole lamp. The simplification of the structure and the ease of assembly and disassembly can save costs and reduce the waste of components.

### FIELD OF THE INVENTION

The present invention relates to a lamp, and more particularly to a detachable video recording sensing lamp.

### BACKGROUND OF THE INVENTION

A conventional monitor device with a lighting device comprises a monitor having a video recording function a sensing floodlight. They are used separately. In addition to the function of light supplement for nighttime photography, the floodlight can produce a certain deterrent effect. Then, a monitor having a video recording function is combined with a sensing floodlight. Taiwan Utility Model Patent No. M324362, No. M398644 and No. M450774 disclose a sensing video recording lamp.

However, the conventional sensing video recording lamp has a whole set of structure and is directly fixed on the wall. Therefore, if the sensing component or the video recording component is damaged, it cannot be replaced individually. The entire lamp must be replaced and it is necessary to install a new one, which not only wastes the cost of the functional components but also requires special personnel for replacement service. This is inconvenient and wastes resources. Accordingly, the inventor of the present invention has devoted himself based on his many years of practical experiences to solve these problems.

### SUMMARY OF THE INVENTION

In view of the aforesaid problem, the primary object of the present invention is to provide a detachable video recording sensing lamp. The user or the consumer can perform assembly according to the desired function. When one of the functional units is damaged, only the damaged functional unit is replaced without the need to replace the whole lamp. The simplification of the structure and the ease of assembly and disassembly can save costs and reduce the waste of components.

In order to achieve the aforesaid object, the detachable video recording sensing lamp of the present invention comprises a light source body and at least one functional unit. The at least one functional unit is detachably electrically connected to the light source body.

In some embodiments, the light source body has a light source and a lamp holder. The light source is mounted on the lamp holder and electrically connected to a power supply. The lamp holder is fixed at a predetermined position.

In some embodiments, the at least one functional unit is a combination of a video recording unit and an infrared sensing unit. The light source body, the video recording unit and the infrared sensing unit are electrically connected to one another through a USB male-female connection means.

In some embodiments, the at least one functional unit is a single video recording unit that is electrically connected to the light source body through a USB male-female connection means.

In some embodiments, the at least one functional unit is a single infrared sensing unit that is electrically connected to the light source body through a USB male-female connection means.

In some embodiments, when the light source body and the at least one functional unit have a first USB plug and a second USB plug respectively, a connector is provided between the light source body and the at least one functional unit. The connector has a USB connection hole for the first USB plug and the second USB plug to be electrically connected simultaneously.

### BRIEF DESCRIPTION OF THE DRAWINGS

FIG. 1 is an exploded view of the detachable video recording sensing lamp in accordance with a first embodiment of the present invention;

FIG. 2 is a perspective view of the detachable video recording sensing lamp in accordance with the first embodiment of the present invention;

FIG. 3 is a top view of the detachable video recording sensing lamp in accordance with the first embodiment of the present invention;

FIG. 4 is a sectional view taken along line A-A of FIG. 3;

FIG. 5 is an exploded view of the detachable video recording sensing lamp in accordance with a second embodiment of the present invention;

FIG. 6 is a perspective view of the detachable video recording sensing lamp in accordance with the second embodiment of the present invention;

FIG. 7 is an exploded view of the detachable video recording sensing lamp in accordance with a third embodiment of the present invention; and

FIG. 8 is a perspective view of the detachable video recording sensing lamp in accordance with the third embodiment of the present invention.

### DETAILED DESCRIPTION OF THE PREFERRED EMBODIMENTS

With regard to the technical means by which the present invention achieves the above-mentioned objects, embodiments of the present invention will now be described, by way of example only, with reference to the accompanying drawings.

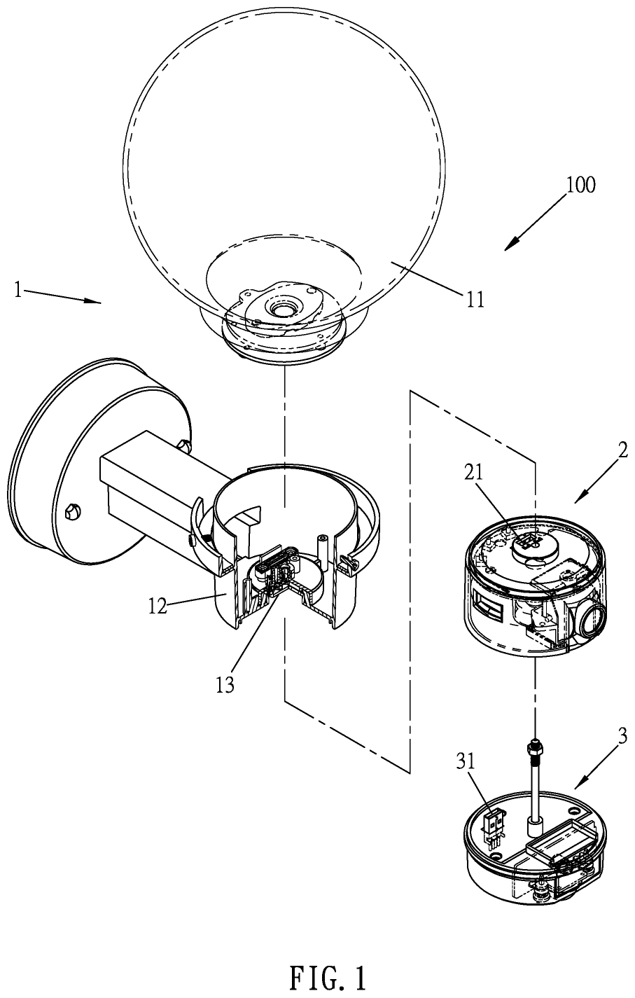

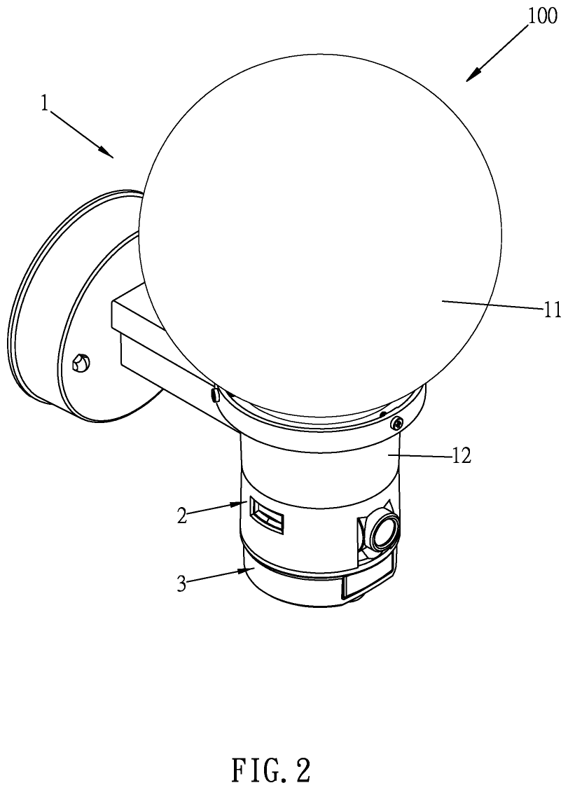

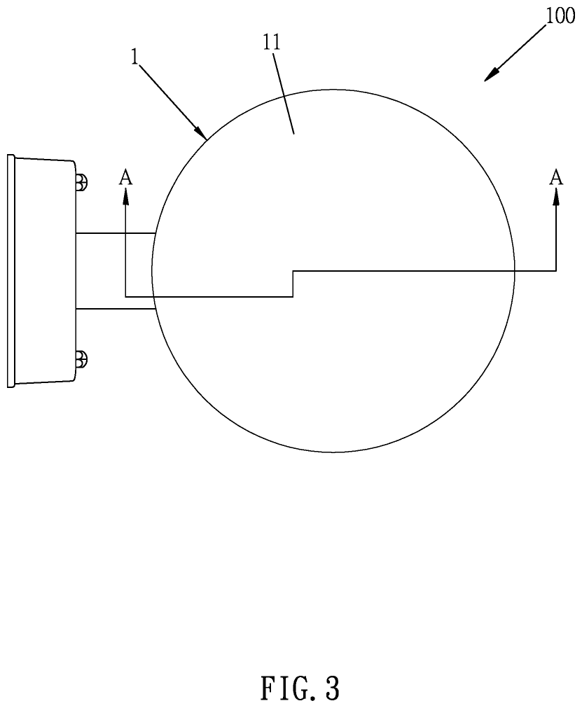

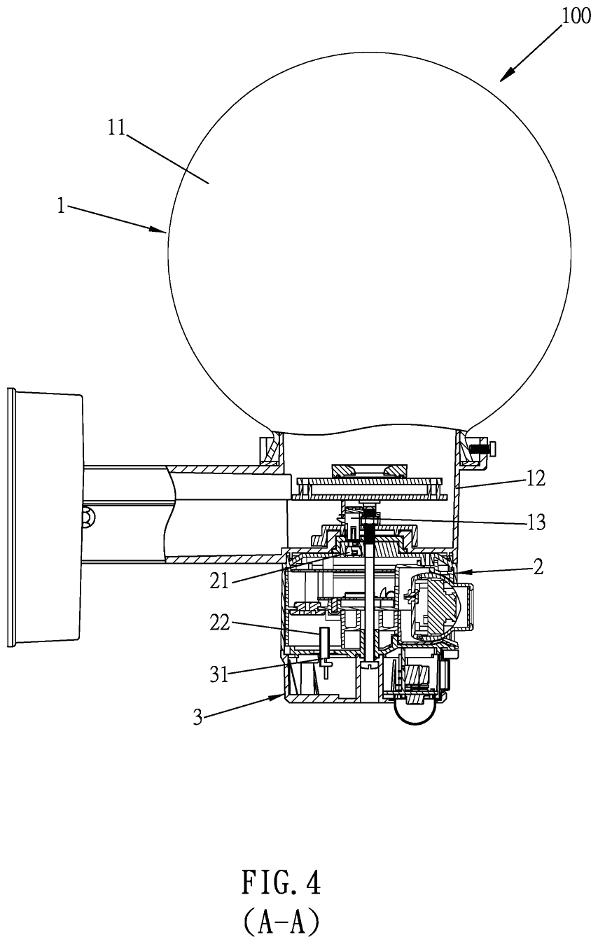

Referring to FIGS. 1 to 8, the detachable video recording sensing lamp 100 of the present invention comprises a light source body 1 and at least one functional unit. The at least one functional unit is detachably electrically connected to the light source body 1.

The light source body 1 has a light source 11 and a lamp holder 12. The light source 11 (such as, a tungsten light bulb, an LED light bulb or a searchlight, etc., but not limited thereto) is mounted on the lamp holder 12 and electrically connected to a power supply (not shown). The power supply may be a mains supply or rechargeable battery (but not limited thereto). The lamp holder 12 may be fixed at a predetermined position, such as a wall in a dark place where illumination and video recording are required.

FIGS. 1 to 5 illustrate a first embodiment of the present invention. In this embodiment, the at least one functional unit is a combination of a video recording unit 2 and an infrared sensing unit 3. The light source body 1, the video recording unit 2, and the infrared sensing unit 3 are electrically connected to one another through a USB male-female connection means. That is, the upper surface of the video recording unit 2 has a first USB socket 21 to mate with a first USB plug 13 on the lower surface of the light source body 1. The upper surface of the infrared sensing unit 3 has a second USB plug 31 to mate with a second USB socket 22 on the lower surface of the video recording unit 2. The mating of the USB plug and the USB socket can be interchanged according to the desired design, but not limited thereto. The positions of the video recording unit 2 and the infrared sensing unit 3 can be exchanged, and the USB male-female design can be adjusted accordingly.

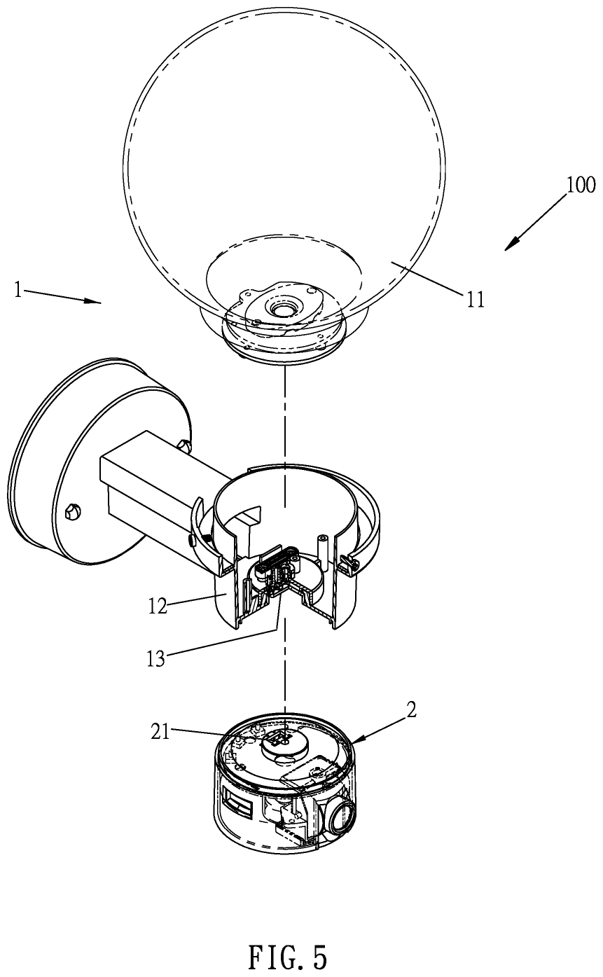

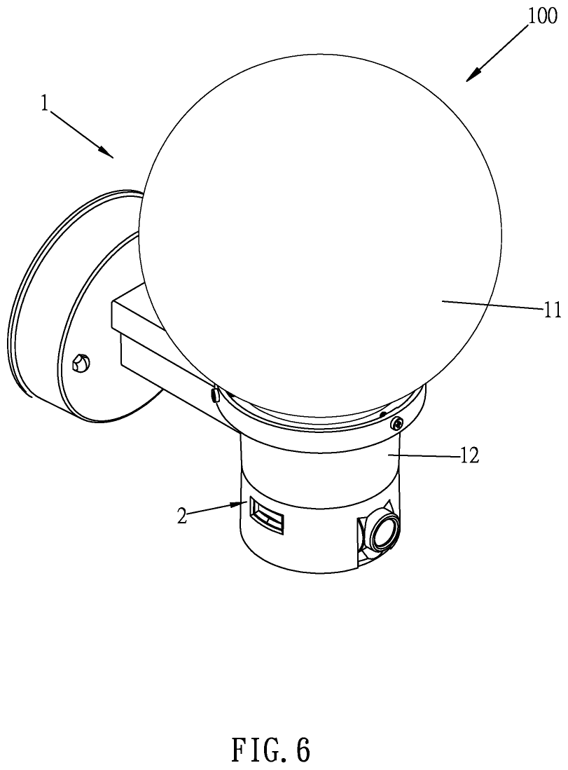

FIGS. 5 and 6 illustrate a second embodiment of the present invention. In this embodiment, the at least one functional unit is a single video recording unit 2 that is electrically connected to the light source body 1 through a USB male-female connection means. The USB male-female connection means is described in the first embodiment and will not be described again.

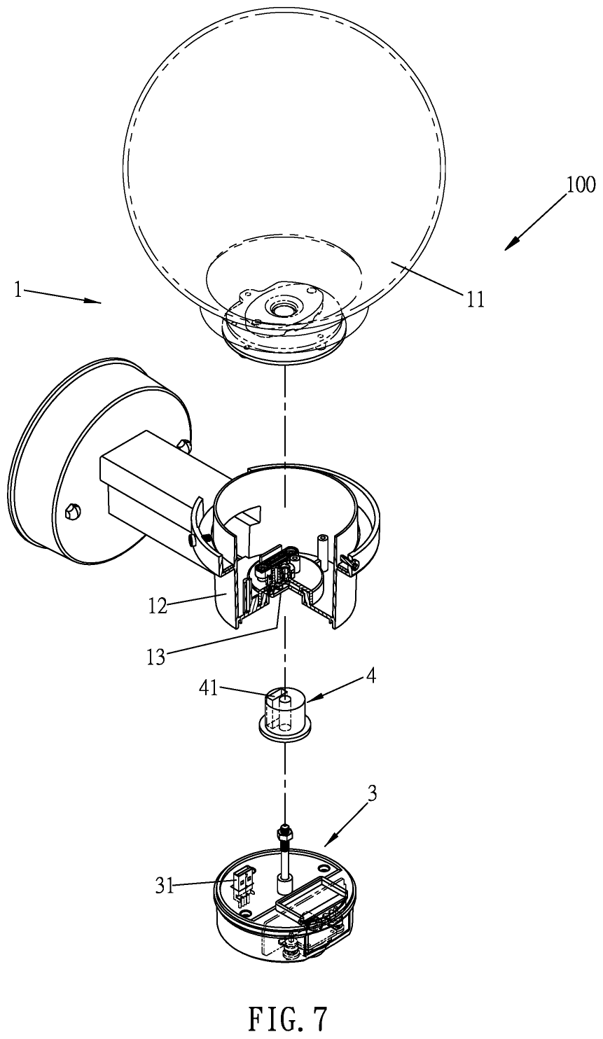

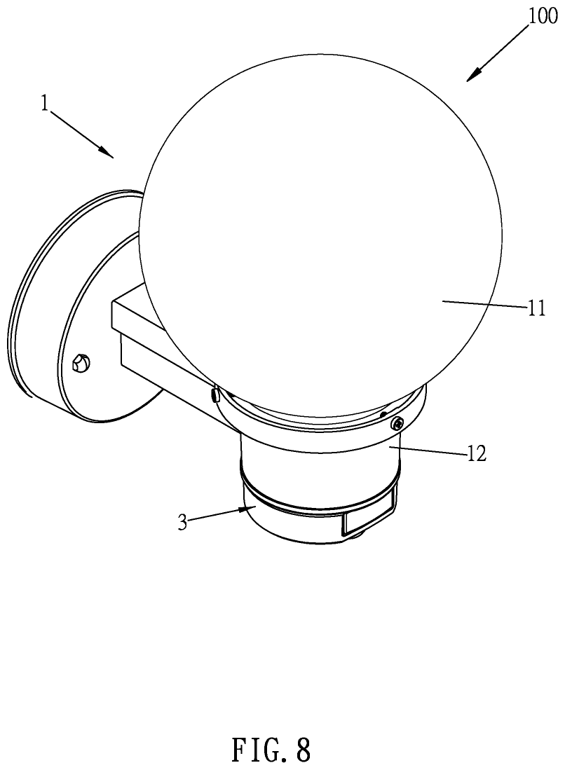

FIGS. 7 and 8 illustrate a third embodiment of the present invention. In this embodiment, the at least one functional unit is a single infrared sensing unit 3 that that is electrically connected to the light source body 1 through a USB male-female connection means. The USB male-female connection means is described in the first embodiment and can be changed according to a required design, and thus will not be described again. However, if both ends are connected with male components (USB plugs 13 and 31), a connector may be provided, for example, between the light source body 1 and the video recording unit 2, between the video recording unit 2 and the infrared sensing unit 3, between the light source body 1 and the infrared light sensing unit 3, etc. As shown in FIG. 7, the present invention uses a connector 4 connected between the light source body 1 and the infrared sensing unit 3, as an example. The connector 4 has a USB connection hole 4, so that the male components (USB plugs 13 and 31) can be electrically connected simultaneously.

In addition, the video recording unit 2 may be connected through a wireless network (WiFi or the like) or a wired network to transmit real-time images to a remote host (not shown) and a screen display and perform monitoring and video recording.

The present invention allows the light source body 1 to be used alone without connecting other functional units. When it is sensed that the environment is dim or at night, the light is on. Furthermore, the light source 11 may be manually turned on in case of need.

In addition, the light source body 1 has a circular joint corresponding to the video recording unit 2 and/or the infrared sensing unit 3. The video recording unit 2 and the infrared sensing unit 3 may be also circular. This will increase the convenience and cooperation for the assembly and disassembly of the three components.

Therefore, according to the above structure, the user or the consumer can perform assembly according to the desired function. When one of the functional units is damaged, only the damaged functional unit is replaced without the need to replace the whole lamp. The simplification of the structure and the ease of assembly and disassembly can save costs and reduce the waste of components.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A detachable video recording sensing lamp, comprising:
a light source body, the light source body having a light source and a lamp holder, the light source being mounted on the lamp holder and electrically connected to a power supply, the lamp holder being fixed at a predetermined position; and
at least one functional unit, detachably electrically connected to the light source body.

2. The detachable video recording sensing lamp as claimed in claim 1, wherein the at least one functional unit is a combination of a video recording unit and an infrared sensing unit, the light source body, the video recording unit and the infrared sensing unit are electrically connected to one another through a USB male-female connection means.

3. The detachable video recording sensing lamp as claimed in claim 1, wherein the at least one functional unit is a single video recording unit that is electrically connected to the light source body through a USB male-female connection means.

4. The detachable video recording sensing lamp as claimed in claim 1, wherein the at least one functional unit is a single infrared sensing unit that is electrically connected to the light source body through a USB male-female connection means.

5. The detachable video recording sensing lamp as claimed in claim 1, wherein when the light source body and the at least one functional unit have a first USB plug and a second USB plug respectively, a connector is provided between the light source body and the at least one functional unit, and the connector has a USB connection hole for the first USB plug and the second USB plug to be electrically connected simultaneously.
